(19) United States
(12) Patent Application Publication
(10) Pub. No.: US 2015/0039679 A1
(43) Pub. Date: Feb. 5, 2015

(54) METHODS AND SYSTEMS FOR RECOMMENDING TOP LEVEL AND SECOND LEVEL DOMAINS

(71) Applicant: Go Daddy Operating Company, LLC, Scottsdale, AZ (US)

(72) Inventors: Arnold Blinn, Hunts Point, WA (US); James Carroll, Los Gatos, CA (US)

(73) Assignee: Go Daddy Operating Company, LLC, Scottsdale, AZ (US)

(21) Appl. No.: 13/965,627

(22) Filed: Aug. 13, 2013

Related U.S. Application Data
(63) Continuation-in-part of application No. 13/956,878, filed on Aug. 1, 2013.

(51) Int. Cl. H04L 29/06

(52) U.S. Cl. CPC H04L 67/42
USPC 709/203

(57) ABSTRACT

Systems and method of the present invention provide for recommending top level domains. An exemplary method may comprise the steps of determining a location of a client computer or a preferred language for a user operating the client computer, generating a domain name comprising a top level domain, a second level domain, an nth level domain and/or a sub domain associated with the location or with the preferred language, and presenting the domain name for registration.

### FIELD OF THE INVENTION

The present inventions generally relate to domain name registration and, more particularly, systems and methods for recommending top level, second level, nth level and/or sub domains based on a location and/or a preferred language determined from user and/or client data.

### SUMMARY OF THE INVENTION

An example embodiment of a method of recommending top level domains based on user and/or client data may comprise the steps of one or more server computers receiving, from one or more client computers, a request for one or more domain names. The server may then request a data comprising: i) a user account for a user operating the client; ii) one or more browser cookies stored on the client; iii) one or more browser settings for a browser running on the client; iv) a uniform resource locator entered into the browser; or v) an internet protocol address of the client. The server may then receive the data and determine, from the data, a location of the client and/or a preferred language for the user of the client. The server may then: identify, within a database, one or more top level domains associated with the location and/or with the preferred language; generate a presentation for display in a browser comprising the one or more domain names, which comprise the one or more top level domains; and transmit the presentation to the client.

The server may also generate one or more domain names comprising a second level, nth level and/or sub domain concatenated to the top level domain, wherein the top level domain, second level domain, nth level domain and/or sub domain are based on the location and/or the preferred language (note: “nth,” as disclosed in this application may represent any level domain name beyond the top level domain name—e.g., second level domain, third level domain, etc.). The server may then present the at least one domain name for registration.

An example embodiment of a system for recommending top level domains based on user and/or client data may comprise one or more domain name software modules running on one or more server computers communicatively coupled to a network and configured to: receive, from one or more client computers, a request for one or more domain names; request a data comprising: i) a user account for a user operating the client; ii) one or more browser cookies stored on the client; iii) one or more browser settings for a browser running on the client; iv) a uniform resource locator entered into the browser; or v) an internet protocol address of the client. The domain name suggestion module and/or the server may then be further configured to: receive the data; determine a location of the client computer and/or a preferred language for the user from the data; identify, within a database, one or more top level domains associated with the location and/or with the preferred language; generate a user interface comprising a presentation for display on the browser of one or more domain names comprising the one or more top level domains; and transmit the user interface to the client for display.

The domain suggestions module and/or the server may be further configured to generate one or more domain names comprising a second level, nth level and/or a sub domain concatenated to the top level domain, wherein the top level domain, second level domain and/or sub domain are based on the location and/or the preferred language. The server may then present the at least one domain name for registration.

The above features and advantages of the present inventions will be better understood from the following detailed description taken in conjunction with the accompanying drawings.

### BRIEF DESCRIPTION OF THE DRAWINGS

FIG. 1 is a flow diagram illustrating a possible embodiment of a method for recommending top level, second level, nth level and/or sub domains.

FIG. 2 illustrates a possible embodiment of a system for recommending top level, second level, nth level and/or sub domains.

FIG. 3 illustrates a more detailed possible embodiment of a system for recommending top level, second level, nth level and/or sub domains.

FIG. 4 is a flow diagram illustrating a possible embodiment of a method for recommending top level, second level, nth level and/or sub domains.

FIG. 5 is an example interface illustrating a possible embodiment of a system and method for recommending top level, second level, nth level and/or sub domains.

FIG. 6 is a flow diagram illustrating a possible embodiment of a method for recommending top level, second level, nth level and/or sub domains.

FIG. 7 is an example interface illustrating a possible embodiment of a system and method for recommending top level, second level, nth level and/or sub domains.

FIG. 8 is a flow diagram illustrating a possible embodiment of a method for recommending top level, second level, nth level and/or sub domains.

FIG. 9 is an example interface illustrating a possible embodiment of a system and method for recommending top level, second level, nth level and/or sub domains.

FIG. 10 is a flow diagram illustrating a possible embodiment of a method for recommending top level, second level, nth level and/or sub domains.

FIG. 11 is an example interface illustrating a possible embodiment of a system and method for recommending top level, second level, nth level and/or sub domains.

FIG. 12 is a flow diagram illustrating a possible embodiment of a method for recommending top level, second level, nth level and/or sub domains.

FIG. 13 is an example interface illustrating a possible embodiment of a system and method for recommending top level, second level, nth level and/or sub domains.

### DETAILED DESCRIPTION

The present inventions will now be discussed in detail with regard to the attached drawing figures, which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between people or organizations that make use of network or computer resources (users). Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as websites. Websites comprise a collection of connected or otherwise related, web pages. The combination of all the websites and their corresponding web pages on the Internet is generally known as the World Wide Web (WWW) or simply the Web.

Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs (including recently-introduced customized gTLDs) allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. If the domain name is not available for registration, the Internet user may keep selecting alternative domain names until an available domain name is found.

Applicant has determined, however, that presently-existing methods and systems only suggest available domain names based upon synonyms of the desired domain name, and do not provide customized TLDs, second level domains (SLD), nth level domains and/or sub domains for the domain name based upon a location and/or a preferred language of the user. Thus, if a user cannot find a desired domain name specific to the user's language and/or current location, the user may have to sacrifice the desired domain name with a TLD, SLD, nth level domains and/or sub domains specific to the language or location for a completely different domain name based on nothing more than synonyms of the desired domain name or a TLD specified by the user.

Applicant has therefore determined that optimal systems and methods may improve on presently-existing domain name suggestion algorithms by determining the location and/or preferred language of the user and suggesting the desired domain name(s), including a TLD, SLD, nth level domain and/or sub domain customized to the location and/or preferred language. Optimally, these systems and methods may determine the location and/or preferred language of the user based upon: a user account for the user; a browser cookie stored on the client computer; a browser setting for a browser running on the client computer; a URL entered into the browser; and/or an IP address of the client computer. Such systems and methods may overcome a lack of TLD, SLD, nth level domain and/or sub domain customization introduced by presently-existing methods and systems.

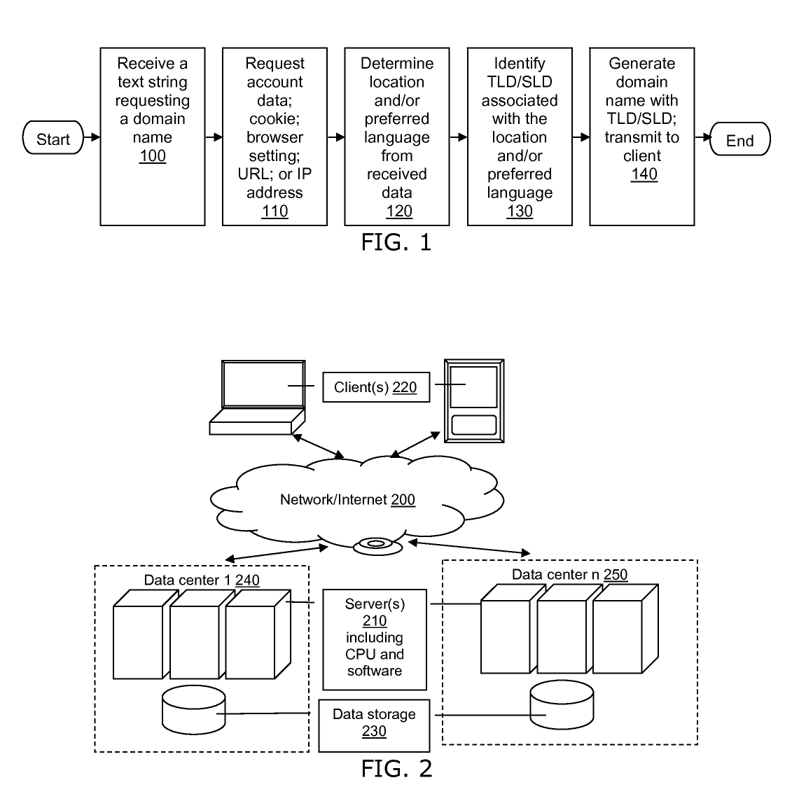

Several different methods may be used to provide and manage the disclosed inventions. In an example embodiment illustrated in FIG. 1, any combination of software modules running on one or more server computers, as described herein, may receive, from one or more client computers communicatively coupled to the network, a request for one or more domain names, the request possibly comprising a text string for requesting the domain name (Step 100), and may request and receive a data comprising: i) a user account for a user operating the client; ii) a browser cookie stored on the client, possibly comprising data generated and stored during a previous session; iii) at least one browser setting for a browser running on the client; iv) a URL entered into the browser; and/or v) an IP address of the client on the network (Step 110).

The method illustrated in FIG. 1 may further comprise the steps of: the server determining, from the data, i) a location of the client; and/or ii) a preferred language for a user operating the client (Step 120); identifying, within a database communicatively coupled to the network, a TLD associated with the location and/or with the preferred language, and/or generating an SLD, nth level domain and/or sub domain associated with the location and/or with the preferred language; (Step 130) and generating and transmitting to the client, for display in the browser, a presentation of the generated domain name comprising the top level domain, the second level domain, the nth level domain and/or the sub domain (Step 140).

Several different environments may be used to accomplish the steps of embodiments disclosed herein. FIG. 2 demonstrates a streamlined example of such an environment and illustrates a non-limiting example of a system and/or structure that may be used to accomplish the methods and embodiments disclosed and described herein. Such methods may be performed by any central processing unit (CPU) in any computing system, such as a microprocessor running on one or more servers 210 and/or one or more clients 220, and executing instructions stored (perhaps as scripts and/or software, possibly as software modules) in computer-readable media accessible to the CPU, such as a hard disk drive on a server(s) 210 and/or client(s) 220.

The example embodiments herein place no limitations on whom or what may comprise users. Thus, as non-limiting examples, users may comprise any individual, entity, business, corporation, partnership, organization, governmental entity, and/or educational institution.

The example embodiments shown and described herein exist within the framework of a network 200 and should not limit possible network configuration or connectivity. Such a network 200 may comprise, as non-limiting examples, any combination of the Internet, the public switched telephone network, the global Telex network, computer networks (e.g., an intranet, an extranet, a local-area network, or a wide-area network), a wired network, a wireless network, a telephone network, a corporate network backbone or any other combination of known or later developed networks.

At least one server 210 and at least one client 220 may be communicatively coupled to the network 200 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The server(s) 210 and client(s) 220 (along with software modules and the data storage 230 disclosed herein) may be communicatively coupled to the network 200 and to each other in such a way as to allow the exchange of information required to accomplish the method steps disclosed herein, including, but not limited to receiving the information from a user interface on one or more clients 220, and one or more servers 210 receiving the information as transmitted by the client(s) 220.

The client 220 may be any computer or program that provides services to other computers, programs, or users either in the same computer or over a computer network 200. As non-limiting examples, the client 220 may be an application, communication, mail, database, proxy, fax, file, media, web, peer-to-peer, or standalone computer, cell phone, “smart” phone, personal digital assistant (PDA), etc. which may contain an operating system, a full file system, a plurality of other necessary utilities or applications or any combination thereof on the client 220. Non limiting example programming environments for client applications may include JavaScript/AJAX (client side automation), ASP, JSP, Ruby on Rails, Python's Django, PHP, HTML pages or rich media like Flash, Flex, Silverlight, any programming environments for mobile “apps,” or any combination thereof.

The client computer(s) 220 which may be operated by one or more users and may be used to connect to the network 200 to accomplish the illustrated embodiments may include, but are not limited to, a desktop computer, a laptop computer, a hand held computer, a terminal, a television, a television set top box, a cellular phone, a wireless phone, a wireless hand held device, a “smart” phone, an Internet access device, a rich client, thin client, or any other client functional with a client/server computing architecture. Client software may be used for authenticated remote access to one more hosting computers or servers, described below. These may be, but are not limited to being accessed by a remote desktop program and/or a web browser, as are known in the art.

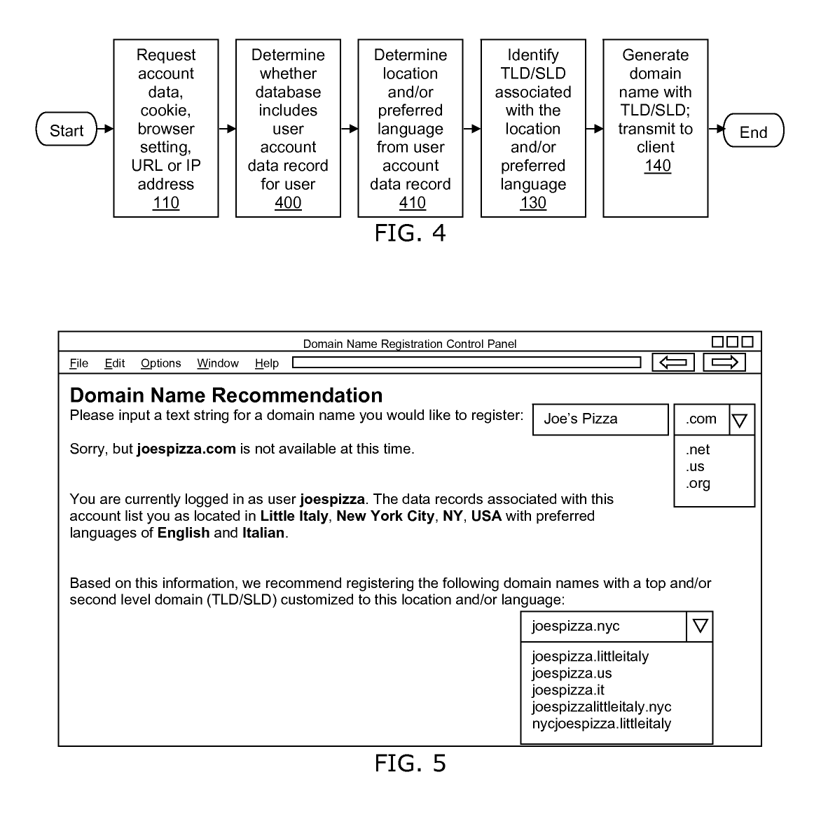

The user interface displayed on the client(s) 220 or the server(s) 210 may be any graphical, textual, scanned and/or auditory information a computer program presents to the user, and the control sequences such as keystrokes, movements of the computer mouse, selections with a touch screen, scanned information etc. used to control the program. Examples of such interfaces include any known or later developed combination of Graphical User Interfaces (GUI) or Web-based user interfaces as seen in and after FIG. 4, including Touch interfaces, Conversational Interface Agents, Live User Interfaces (LUI), Command line interfaces, Non-command user interfaces, Object-oriented User Interfaces (OOUI) or Voice user interfaces. Any information generated by the user, or any other information, may be accepted using any field, widget and/or control used in such interfaces, including but not limited to a text-box, text field, button, hyper-link, list, drop-down list, check-box, radio button, data grid, icon, graphical image, embedded link, etc.

The software modules used in the context of the current invention may be stored in the memory of—and run on—at least one server 210 and/or client 220. The software modules may comprise software and/or scripts containing instructions that, when executed by a microprocessor on a server 210 and/or client 220, cause the microprocessor to accomplish the purpose of the module or the methods disclosed herein. The software modules may also include mobile applications, possibly on a client computer and/or mobile device. These mobile applications, or “apps” may comprise computer software designed to help people perform an activity and designed to help the user to perform singular or multiple related specific tasks. It may help to solve problems in the real world by manipulating text, numbers, graphics, or a combination of these elements.

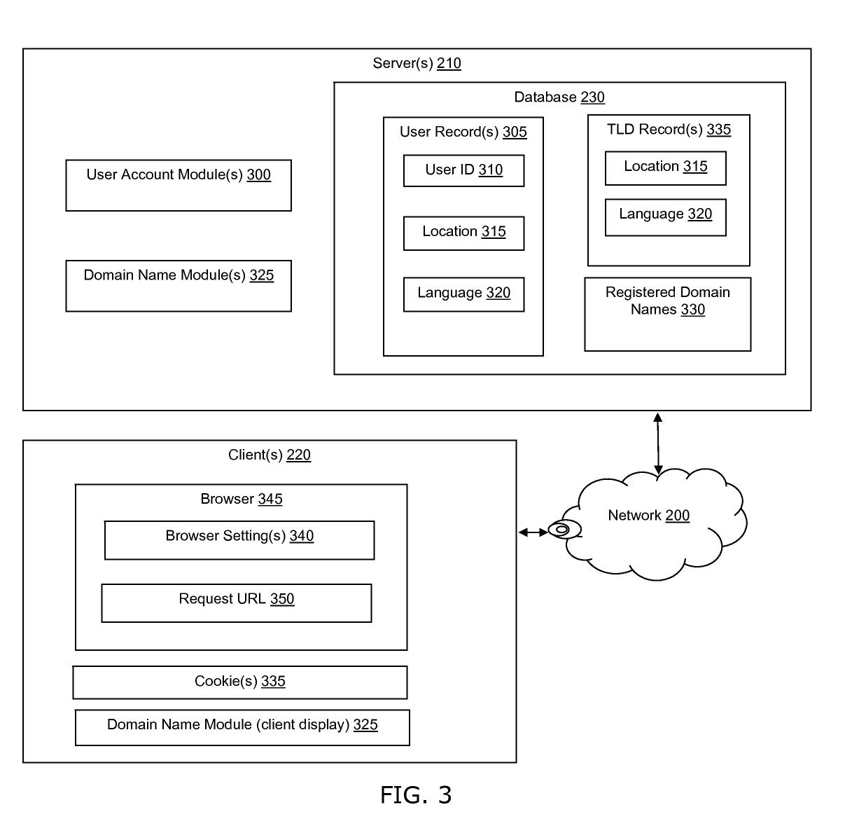

The environment(s) in FIGS. 2-3 may include one or more centralized software modules capable of connecting to any type of software within the environment. In some embodiments, this centralized software may comprise an Application Programming Interface (API) and any request to the API disclosed herein may comprise a Remote Procedure Call (RPC) to the API. An API may comprise a service made available to third parties, which may further comprise any individual, entity, system, hardware, or software wishing to access the disclosed information and functionality. Such an API may comprise a software-to-software interface that specifies the protocol defining how independent computer programs interact or communicate with each other. It also may comprise a collection of pre-configured building blocks allowing a third party to easily configure their software for compatibility and/or extensibility. The API may allow a requesting party's software to communicate and interact with the software application and/or its provider—perhaps over a network—through a series of function calls (requests for services). It may comprise an interface provided by the software application and/or its provider to support function calls made of the software application by other computer programs.

The API may comprise any API type known in the art or developed in the future including, but not limited to, request-style, Berkeley Sockets, Transport Layer Interface (TLI), Representational State Transfer (REST), Simple Object Access Protocol (SOAP), RPCs, Standard Query Language (SQL), file transfer, message delivery, and/or any combination thereof. The API may comprise computer-readable code that, when executed, causes the API to receive an RPC (i.e., function call) requesting information services. Responsive to receipt of the RPC, the API may perform the above described processes, and transmit a request results to the requesting third party. To submit the request via an RPC to the API, the server(s) 210 may require authentication with the API. Computers or servers may locate the API via an access protected URL mapped to the API, and may then use an API key configured to authenticate the one or more computers or servers prior to accessing the API.

The server(s) utilized within the disclosed system 210 may comprise any computer or program that provides services to other computers, programs, or users either in the same computer or over a computer network 200. As non-limiting examples, the server 210 may comprise application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, a cloud hosting solution, a grid hosting solution, or any combination thereof). The server(s) 210 may exist within a server cluster, as illustrated. These clusters may include a group of tightly coupled computers that work together so that in many respects they can be viewed as though they are a single computer. The components may be connected to each other through fast local area networks which may improve performance and/or availability over that provided by a single computer.

The server(s) 210 or software modules within the server(s) 210 may receive hypertext transfer protocol (HTTP) requests for files or other data stored on the server(s) 210 and may use server-side scripting languages such as ASP, PHP, CGI/Perl, proprietary scripting software/modules/components etc. to render the files requested and respond with the rendered files/pages to be displayed on the client(s) 220.

The server(s) 210 or software modules within the server(s) 210 may use query languages such as MSSQL or MySQL to retrieve the content from data storage 230. Server-side scripting languages such as ASP, PHP, CGI/Perl, proprietary scripting software/modules/components etc. may be used to process the retrieved data. The retrieved data may be analyzed in order to determine information recognized by the scripting language, information to be matched to those found in data storage, availability of requested information, comparisons to information displayed and input/selected from the user interface or any other content retrieval within the method steps disclosed herein.

The server 210 and/or client 220 may be communicatively coupled to data storage 230 to retrieve any information requested. The data storage 230 may be any computer components, devices, and/or recording media that may retain digital data used for computing for some interval of time. The storage may be capable of retaining stored content for any data requested, on a single machine or in a cluster of computers over the network 200, in separate memory areas of the same machine such as different hard drives, or in separate partitions within the same hard drive, such as a database partition.

Non-limiting examples of the data storage 230 may include, but are not limited to, a Network Area Storage, (“NAS”), which may be a self-contained file level computer data storage connected to and supplying a computer network with file-based data storage services. The storage subsystem may also be a Storage Area Network (“SAN”—an architecture to attach remote computer storage devices to servers in such a way that the devices appear as locally attached), an NAS-SAN hybrid, any other means of central/shared storage now known or later developed or any combination thereof.

Structurally, the data storage 230 may comprise any collection of data. As non-limiting examples, the data storage 230 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage such as a magnetic media, hard drive, other disk drive, volatile memory (e.g., RAM), non-volatile memory (e.g., ROM or flash), and/or any combination thereof.

As seen in FIG. 2, the software modules, server(s) 210 and/or data storage 230 may exist and/or be hosted in one or more data centers 240, 250. These data centers 240, 250 may provide hosting services for websites, services or software relating to stored information, or any related hosted website including, but not limited to hosting one or more computers or servers in a data center 240, 250 as well as providing the general infrastructure necessary to offer hosting services to Internet users including hardware, software, Internet web sites, hosting servers, and electronic communication means necessary to connect multiple computers and/or servers to the Internet or any other network 200.

As users access and/or input information, this information may be redirected and distributed between and among the data centers 240, 250 via commands from any combination of software modules hosted on the server(s) 210 and executed via processors on the server(s) 210. This information may then be accessed and manipulated by the combination of software modules or stored in the data storage 230 of any of a plurality of data centers, either separate from or integrated into the one or more servers, so that the information is available to be searched and accessed by the user and/or any other components of any or all data centers.

Any references to “software combination,” “combination of software,” “combination of software modules” etc. referred to herein may include any combination of software modules executed by a microprocessor on either the server 210 or client 220 computers. These software modules may also be used in combination with any other method steps, hardware and/or software structures disclosed herein. The servers 210 may be hosted in any data center 240, 250 operated by any hosting provider such as those disclosed herein and the servers 210 and clients 220 may be operated by any users disclosed herein.

In the interest of simplicity, FIG. 3 shows a consolidated environment for accomplishing the methods disclosed herein, where the components of the system are all hosted on a single server computer 210 in a single data center 240, 250. Other embodiments, however, may utilize a highly distributed environment wherein the various system components are each hosted on their own separate server 210 and communicatively coupled to one another via the network 200. Thus, any combination of the disclosed software may be hosted on any combination of server(s) 210 and communicatively coupled to the network 200.

As seen in FIG. 3, the server(s) 220 may host and run one or more user account software modules 300. These user account module(s) 300 may be configured to access an administrative account for a user of the services provided by a business entity (e.g., GO DADDY'S MANAGE YOUR ACCOUNT administration software, as a non-limiting example). This account may also be known as a “user account,” “customer account” or “shopper account” for a user.

Non-limiting examples of the business entities that may provide these services may include a domain name registry, a domain name registrar, a hosting provider, a secure sockets layer (SSL) or other online security Certification Authority (CA), a software development or e-commerce company, etc. Non-limiting examples of the services provided by such a service provider may include, as non-limiting examples, domain name registration and maintenance services, web hosting and maintenance services, website development and maintenance services, SSL certificate validation, signing and issuance services, installation of SSL certificates on hosted websites, DNS services (e.g., domain name/URL resolution, and/or hosting a DNS software, database server, relevant zone, or other DNS files and/or a DNS database), email services, calendaring/scheduling services, online storage services, fax services, etc. Any combination of these services may be provided by a single service provider.

The user account module(s) 300 may provide access to the service provider's services via the administrative user account. As non-limiting examples, the user account module(s) 300 may provide access to an administrative account and/or server-generated control panel interface for each of the various services provided through the user account. These one or more control panel interfaces may be accessible via any client 220 and may comprise, as non-limiting examples, a web page, a client side program, an “app,” a server administration interface, etc. In some embodiments, access to the services may be provided via one or more administration and/or control panel interfaces, possibly generated by the server(s) 210 and transmitted to clients 220 as webpages accessible via the Internet.

To create a user account, the user account module(s) 300 may be configured to generate and transmit, for display on the client(s) 220, a user account signup interface, possibly a web page or other client-side user interface. The signup interface may be configured to receive, from the user, a request to create a user account, including a username and password for the user account. The signup interface may be further configured to receive additional information from and about the user, including contact information such as a phone number, SMS messaging contact information, email address, etc.

The signup interface may further be configured to transmit the user's information to the server(s) 210. The server(s) 210 may receive this information, and store the information in a database 230 or other storage system, as described herein. In some embodiments, such as that shown in FIG. 3, the information may be stored as a user account data record 305 within the database 230, possibly in a user account data table. Each user account record 305 stored in the database 230 may be assigned a unique user account identification (“user ID,” sometimes referred to as a customer ID or a shopper ID) 310. In some embodiments, this user ID 310 may be a unique number auto-generated and assigned, by the database, to the record created for the user account 305 in the database 230, the user ID 310 for each record being auto-incremented from the last. In other embodiments, the user account module(s) 300 may assign each new user account a unique user ID 310. The user ID 310 may be included (possibly as a foreign key) within all records stored in the database 230 that are associated with this “master” user account.

The user may create an account according to any means of user information collection known in the art. As a non-limiting example, the user account may be created via a purchase path for one or more products available from the service provider. The user may request, and the server(s) 210 may receive the request from the client(s) 220, to create the user account for the user.

During this user account creation process, the user may be prompted to create and/or select a username and a password. This username and password may be used to authenticate the user when the user accesses the products provided by the service provider, including the domain name software module(s) 325 disclosed herein. As a non-limiting example, to access the disclosed domain name software module(s) 325, the user may be prompted for the username and password. After a client 230 transmits the username and password to the server computer, the server(s) 210 may search the database 230 to determine if the received username and password exist within a user account record 305 stored in the database 230. If so, the server(s) 210 may authenticate the user to the domain name software module 325.

The user may also provide additional personal information during the account creation process. As a non-limiting example, and for purposes of the disclosed invention, the user may provide a location 315 of the user and/or the client(s) 220 being operated by the user and/or a preferred language 320 for the user. The server(s) 210 may therefore be configured to request, receive and/or store in the database 230, a user account record 305 comprising a username for the user, a password for the user, the location 315 of the user/client and/or the preferred language 320 of the user.

The location 315 information may comprise any location 315 provided by the user or detectible by techniques described herein or known in the art. Non-limiting examples of such a location 315 may include the user's continent, country, region, state, province, county, city, neighborhood, street address, zip code, etc. or any combination thereof.

As a non-limiting example: Joe, an owner of a pizza restaurant and a user of the disclosed system, may operate his business from Little Italy, New York City, N.Y., USA. As he sets up his user account, he may provide a username “joespizza” and password “pepperoni.” As prompted, he may include his preferred languages 320 as English and Italian and may include his location 315 as 123 Restaurant Road, Little Italy, New York City, N.Y., USA. Joe may also provide additional details about his address, phone number or any other contact or personal information to be included in the user account data record 305.

One non-limiting example of the products/services offered by the service provider may include registering domain names for users/customers. In some embodiments, this service may be provided by a registrar capable of registering domain names. As non-limiting examples, the service provider may be a registrar for generic TLDs (gTLD) such as .com, .net, .edu, .org, etc. In the context of the current invention, the registrar may also be a registrar of customized gTLDs such as .domainnames, .godaddy, .nyc, .newyork, .littleitaly etc. or country-code TLDs (ccTLD) and/or ccTLDs that have an affinity for a specific language and or locale. Non limiting examples may include.us, .it, etc. Registrars may need to take the steps necessary to qualify as registrars for these customized TLDs and/or ccTLDs according to qualifying steps known in the art.

The registrar may store, in the database 230, information about domain names registered with the registrar and the TLDs associated with the domain names (and for which the registrar is authorized to register) 330. As non-limiting examples, the registrar may store one or more TLD records 335 in the database 230 for each of the TLDs for which that the registrar is qualified and authorized to register. Within these one or more TLD records 335, the registrar may associate the TLD that is the subject of the record(s) 335 with one or more locations 315 and/or one or more languages 320. In some embodiments, the location(s) 315 and/or languages 320 associated with the TLD in the database may be stored in one or more records (not shown) corresponding to the one or more TLD records 335. In addition to registering domain names and storing information about the domain name registrations, the registrar may also store data and/or have access to data about all names in the root.

The registrar may store one or more records of registered domain names 330. As non-limiting examples, the records of registered domain names 330 may comprise zone files downloaded from a domain name registry. Likewise, records of registered domain names 330 may comprise records within a registrar database 330 created and/or updated each time a new domain name is registered (or transferred, perhaps via domain name aftermarket) with the registrar. No limitations should be placed on the manner in which the domain name module 325 determines the availability of domain names. As non-limiting examples, the domain name module(s) 325 may determine available domain names to be those domain names not listed in the zone files and/or found in the database 230 for a particular text string combined with a TLD.

The user may access, possibly after authenticating to their user account, one or more domain name software modules 325 running on the server(s) 210. The domain name module(s) 325 may comprise a component for recommending, registering and/or administrating domain names. This component may further comprise a module for recommending a domain name and/or TLD if a domain name requested by a user is determined to be unavailable. Recommendations for domain names may include domain names that have not yet been registered, domain names available in a domain name aftermarket and/or services for contacting current domain owners to determine if the current registrant is willing to sell their domain name(s).

As seen in the non-limiting example in FIGS. 5, 7, 9, 11 and 13, a user interface/control panel for the domain name software module(s) 325 may be displayed on the client(s) 220. The user interface/control panel for the domain name module(s) 325 may be configured to receive one or more requested domain names from a user. As seen in FIGS. 5, 7, 9, 11 and 13, the requested domain name may comprise a text string and/or a selected TLD received from the user and transmitted to the domain name module(s) 325. This text string may comprise a specific domain or a plurality of random terms and may be used to identify one or more related domain names that are available or soon will be available for registration.

The domain name module(s) 325 may be configured to receive the requested domain name from the user interface on the client(s) 220 and search the records of registered domain names 330 to determine if the requested domain name is available. If the requested domain name is available, the domain name module(s) 325 may be configured to receive a request/selection by the user to register the available domain name and may be further configured to register the domain name and/or administrate the domain name according to any technique for domain name registration and/or administration known in the art.

Continuing the non-limiting example above, and as seen in FIGS. 5, 7, 9, 11 and 13, a user may type the string “Joe's Pizza” (or alternatively “joespizza”) into a user interface element (possibly a text box) on the user interface. In the illustrated non-limiting embodiments, the user may also select a TLD associated with the entered text string as part of the domain name search (e.g., “.com” is selected from a drop down in these non-limiting examples). The displayed control panel may then be configured to transmit the entered form data to the domain name module 325 running on the server(s) 210. If joespizza.com is available for registration, the domain name module(s) 325 may be configured to transmit, for display on the client(s) 220, a notification that the domain name is available, and guide the user through the process of registering joespizza.com.

However, if the requested domain name is not available for registration, the domain name module(s) 325 may be configured to calculate, identify and generate alternative domain names to be suggested to the user. The alternative and/or additional “spun” domain name may comprise either one or more similar domain names with the same TLD and/or one or more available domain names with a different TLD. If the “spun” domain name(s) are selected by the user, the domain name module(s) 325 may be configured to register the domain name(s) selected by the user, and administrate the registered domain names accordingly.

Continuing the non-limiting example above, the domain name module(s) 325 may be configured to determine that, if joespizza.com is not available, joespizza.net or joespizza.us are available, and may transmit these suggested domain names to the client(s) 220 for display. The domain name module(s) 325 may be configured to receive a selection of an available domain name and guide the user through the process of registering and administrating joespizza.com.

In embodiments recommending one or more domains with the same (or a different) string and a different TLD, the domain name module(s) 325 and/or the server(s) 210 may be configured to recommend the TLD, SLD, nth level domain and/or sub domain according to the location 315 of the client(s) 220 and/or the preferred language 320 of the user of the client(s) 220. The location 315 of the client(s) 220 should not be limited. As non-limiting examples, any location from an individual residence to a continent may be included in the definition of a client location, including, but not limited to a housing development, neighborhood, borough, city, county, zip code, state, country, etc.

Thus, the disclosed inventions may recommend location and/or language specific SLDs, nth level domains and/or subdomains according to a more “granular” approach to recommending available (or soon to be available) domain names, including specific ccTLDs or gTLDs. Continuing the example above, if Joe has a restaurant in Little Italy in New York City, and joespizza.com is not available for registration, the domain name module(s) 325 may be configured to determine Joe's location 315 and/or preferred language 320 and recommend alternative domain names using location and/or language specific TLDs, SLDs, nth level domains and or sub domains, such as joespizzalittleitaly.nyc, nycjoespizza.littleitaly, joespizza.nyc, joespizza.newyork, joespizza.littleitaly, joespizza.us, joespizza.it, etc., as non-limiting examples.

To recommend the TLD according to the location 315 and/or the preferred language 320, the domain name module(s) 325 may be configured to determine the location 315 of the client(s) 220 and/or a preferred language 320 for the user of the client(s) 220 and generate domain name recommendations based on the TLDs 335 associated in the database 230 with the location 315 and/or preferred language 320. To accomplish this, the domain name module(s) 325 may be configured to determine the location 315 or preferred language 320 based upon: i) a user account for the user; ii) a browser cookie 335 stored on the client computer 220; iii) at least one browser setting 340 for a browser 345 running on the client computer 220; iv) a URL entered into the browser 350; and/or v) an internet protocol address of the client computer 220 on a network 200.

The domain name module(s) 325 may be configured to recommend the SLD, nth level domain and/or sub domain within the domain name according to any domain name suggestion techniques known in the art. As a non-limiting example, to recommend an SLD, nth level domain and/or sub domain according to the location 315 and/or the preferred language 320, the domain name module(s) 325 may be configured to identify, within the text string from the request to determine the availability of the domain name, one or more keywords. The domain name module(s) 325 may be further configured to generate the SLD, nth level domain and/or sub domain from the identified keyword(s), so that the SLD, nth level domain and/or sub domain within the recommended domain name comprises the identified keyword(s).

The domain name module(s) 325 may then be configured to identify the location 315 and/or preferred language 320 according to steps disclosed herein, and may include the location 315 and/or preferred language 320 as a text string within the generated SLD, nth level domain and/or sub domain. In some embodiments, the location 315 and/or preferred language 320 may be appended as a prefix or a suffix to the keyword(s) within the generated SLD. The SLD, nth level domain and/or sub domain may then be concatenated to any gTLD, ccTLD or other TLD to complete the full domain name. In some embodiments, the SLD, nth level domain and/or sub domain may be concatenated to a TLD generated based on the location 315 and/or preferred language 320 as disclosed herein.

From the non-limiting example disclosed herein, the domain name module(s) 325 may be configured to receive the example text string “Joe's Pizza” or “joespizza” from the domain name module(s) 325 user interface. The domain name module(s) 325 may be configured to identify, within the text string, the keywords “joes” and “pizza,” and may generate the SLD “joespizza” from these keywords. The SLD “joespizza” may then be combined with a text string representing the location 315 and/or preferred language 320, which may be appended as a prefix or suffix to the keywords, resulting in “joespizzalittleitaly” or “nycjoespizza,” as non-limiting examples. The SLD may then be concatenated to a TLD, possibly based on the location 315 and/or preferred language 320, thereby generating the domain names joespizzalittleitaly.nyc or nycjoespizza.littleitaly, as non-limiting examples.

The domain name module(s) 325 may then be configured to compare the generated SLD/TLD combination to the registered domain name data in the database 230 to determine if the generated suggested domain names have already been registered. If not, the SLD/TLD combination may be transmitted to the client(s) 220 for display as a suggested domain name.

In some embodiments, the sources used to determine the location 315 of the client(s) 220 and/or the preferred language 320 for the user of the client(s) 220 (i.e. user record 305, cookie(s) 335, browser setting(s) 340, URL 350, IP address, etc.) may be utilized in a “cascading” order. As a non-limiting example, the domain name module(s) 325 and/or the server(s) 210 may first determine whether a user account data record 305 exists for the user, and identify the location 315 and/or the preferred language 320 from the user account data record 305. If no user account data record 305 exists for the user, the domain name module(s) 325 and/or the server(s) 210 may determine whether one or more cookies 335 have been stored on the client(s) 220 and determine the location 315 and/or preferred language 320 from the cookie(s) 335. If no cookie 335 exists on the server, the domain name module(s) 325 and/or the server(s) 210 may determine the location 315 and/or preferred language 320 from one or more browser settings 340 and so forth.

In embodiments that determine the location 315 and/or preferred language 320 based upon a user account for the user, the domain name module(s) 325 may be configured to determine whether the database 230 comprises one or more user account data record(s) 305 for the user. If so, the domain name module(s) 325 and/or server(s) 210 may be configured to identify, within the user account data record(s) 305, the location 315 and/or the preferred language(s) 320.

One non-limiting example of determining whether the database 230 comprises a user account data record 305 for the user may include the user account module(s) 325 and/or domain name module(s) 325 determining whether the user has been authenticated to a user account. In some embodiments, this authentication may be determined according to whether a session variable is included within a current session for the user. The user ID 310 session variable may indicate to the module(s) 300, 325 that the user has previously been authenticated by identifying the user ID 310 within a user account record 305 in the database 230.

In some embodiments, the user account record 305 comprising the user ID 310 may be identified according to a username/password combination submitted to the server 210. The server may then be configured to determine whether a user account data record 305 is found in the database comprising the username/password combination and/or the user ID 310 for the session.

In some embodiments, if no user ID 310 and/or username/password combination has been identified, the server(s) 210 may be configured to request and receive a username and/or password from the user, and determine whether a user account data record 305, comprising the username and/or password, exists within the database 230. If so, the user may be authenticated, and the data from the user account data record 305 may be made available to the user account module(s) 300 and/or the domain name module(s) 325.

Regardless of the method used, once the user account data record 305 is identified, a location 315 and/or preferred language 320 may be identified within the user account data record 305 if the user has previously provided such information. If the location 315 and/or preferred language 320 is found within the user account data record 305, the domain name module(s) 325 may be configured to identify one or more TLD's associated, within TLD data records 335 as described herein, with the location 315 and/or preferred language 320 in the user account data record 305. As seen in the non-limiting example embodiment shown in FIG. 5, the domain name module(s) 325 may be configured to generate one or more recommended domain names including the one or more TLDs 335, SLDs, nth level domains and/or sub domains associated with the location 315 and/or preferred language 320. These generated domain names may then be transmitted to the client(s) 220 for display on a user interface and/or control panel.

In embodiments that determine the location 315 or preferred language 320 based upon one or more cookies 335 stored on the client(s) 220, the domain name module(s) 325 may be configured to determine whether the cookie(s) 335 from a previous session are stored on the client(s) 220. If so, the domain name module(s) 225 and/or server(s) 210 may be configured to receive the cookie(s) 335 from the client 220 as the cookies are automatically sent by a browser. The domain name module(s) 325 may further be configured to identify, within the cookie(s) 335, the location 315 and/or the preferred language(s) 320.

In these embodiments, the server(s) 210 may generate and write one or more browser or other “cookies” 335 to the client(s) 220. The cookie(s) 335 may comprise data about a user's Internet session. The data about the user's session may comprise various information about the user, website, and or interactions between the user and various websites. During these interactions, the websites and/or server(s) 210 may write the cookie(s) 335 to the client(s) 220. The data within the cookie(s) 335 may comprise, as non-limiting examples, the location of the client computer 315 and/or a preferred language for a user of the client computer 320. As non-limiting examples, in some embodiments, the user may provide the location 315 and/or preferred language 320 written within the cookie(s) 335. In other embodiments, the cookie(s) 335 may be written by the server(s) 210 based upon a location 315 and/or or preferred language 320 as determined by particular visited websites and/or web pages. As non-limiting examples, the information from the websites may be determined via URL or browser settings as described below.

If the domain name module(s) 325 and/or server(s) 210 determine that the cookie(s) 335 have been stored on the client(s) 220 and comprise the location 315 and/or preferred language 320, the server(s) 210 may be configured to identify data within the cookie(s) 335 comprising the location 315 and/or preferred language 320. If the location 315 and/or preferred language 320 is found within the cookie(s) 335, the domain name module(s) 325 may be configured to identify one or more TLD's associated, within TLD data records 335 as described herein, with the location 315 and/or preferred language(s) 320. As seen in the non-limiting example embodiment shown in FIG. 7, the domain name module(s) 325 may be configured to generate one or more recommended domain names including the one or more TLDs, SLDs, nth level domains and/or sub domains associated with the location 315 and/or preferred language(s) 320. These generated domain names may then be transmitted to the client(s) 220 for display on a user interface and/or control panel.

In embodiments that determine the location 315 or preferred language 320 based upon one or more browser settings 340 stored within an Internet or other browser 345 running on the client(s) 220, the domain name module(s) 325 may be configured to request and/or receive, from the client(s) 220, the one or more browser settings 340. The browser 345 running on the client(s) 220 may include various settings and configuration information, which may include, as non-limiting examples, a geo location 315 of the client(s) 220 and/or a language preference 320 setting for the operator of the browser 345.

As a non-limiting example, the browser 345 may be “geo enabled,” allowing the browser 345 to determine and store the physical location 315 of the client(s) 220. The location of the browser 345 may be determined using “geo location providers,” which may provide requested geo location 315 information from a source provider (e.g., Google would be a source provider for users determining their geo location from Google's Chrome browser). The source provider may then provide the requested geo location 315 information. In other embodiments, the browser 345 may send local network 200 information to the source provider (e.g., Google Location Services) to get geo location 315 information.

The browser 345 may then store the geo location 315 information and/or share the client's 220 geo location 315 with the requesting server(s) 210. Using the browser's 345 geo location 315 settings, the browser may allow all sites to track the client's 220 physical location 315. Other non-limiting examples of location-based browser settings 340 may include Firefox: (e.g., {“location”: {“latitude”: 48.861426,2.338929, “longitude”: 2.338929, “accuracy”:20.0}}), or, if the browser 345 has a geo.enabled setting set to true, the physical location 315 information may be transmitted and/or pulled from the browser's 345 about:config information.

The browser settings 340 received by the server(s) 210 may also include a preferred language 320 for which website content displayed on the browser 345 is to be generated and displayed. As non-limiting examples, for Internet Explorer, the server(s) 210 may receive the values and/or settings from the browser's 345 Tools>Internet Options>General>Languages parameters. Likewise, for Firefox, the server(s) 210 may receive the values and/or settings from tools>options>content>languages and/or a window.navigator.language function to transmit a string representing the language version of the browser 345.

Regardless of the method used, once the browser settings for location 315 and/or preferred language 320 are be identified within the browser settings 340, the location 315 and/or preferred language 320 identified within the browser settings 340 may then be used to identify, within the database 230, one or more TLD's records 335 previously associated, within the database 230, with the location 315 or preferred language 320 as described herein.

If the server(s) 210 determine that the browser settings 340 have been stored on the client(s) 220 and comprise the location 315 and/or preferred language 320, the server(s) 210 may be configured to identify data within the browser setting(s) 340 comprising the location 315 and/or preferred language 320. If the location 315 and/or preferred language 320 is found within the browser settings 340, the domain name module(s) 325 may be configured to identify one or more TLD's associated, within TLD data records 335, with the location 315 and/or preferred language 320. As seen in the non-limiting example embodiment shown in FIG. 9, the domain name module(s) 3 may be configured to generate one or more recommended domain names including the one or more TLDs, SLDs, nth level domains and/or sub domains associated with the location 315 and/or preferred language 320. These generated domain names may then be transmitted to the client(s) 220 for display on a user interface and/or control panel.

In embodiments that determine the location 315 and/or preferred language 320 based upon a URL 350 used to send a request to the server(s) 210 from a browser 345 running on the client(s) 220, the domain name module(s) 325 may be configured to identify a substring within the URL representing, as non-limiting examples, a location 315 of the client(s) 220 and/or a preferred language 320 for the operator of the browser 345.

As a non-limiting example, the domain name module(s) 325 may be accessible via a web page on a registrar website. To access the user interface/control panel for the domain name module(s) 325, a user may enter the URL http://it.domaincontrolpanel.nyc into the appropriate address bar in a web browser 345. For purposes of this non-limiting example, the sub domain “it” may indicate that the preferred language for the user that accessed the website is Italian. The customized TLD “.nyc” may indicate that the location of the user is New York City, N.Y. . Such a customized URL may be used, among other things, to customize a website content to a specific client location 315 and/or to a primary language 320 of the website/domain name module 325 user.

The domain name module(s) 325 may be configured to receive the request to resolve the web page, and further analyze the received request URL 350 to determine and identify one or more sub strings within the URL 350 representing a client location 315 for which a website content should be customized and/or a primary language 320 for which the website content should be customized. As non-limiting examples, the sub string may comprise a sub domain, TLD and/or a website path representing sub folders within the website (e.g., /it/ or /nyc/). In this non-limiting example, the domain name module(s) 325 may further be extrapolate additional information from the URL. For example, the domain name module(s) 325 may be configured to determine, based on the user's preferred language 320 being Italian, and the location 315 of the client(s) 220 being New York City, that the user is accessing the web page from Little Italy in New York City.

If the server(s) 210 determine that the URL comprises one or more substrings representing a client location 315 and/or a primary/preferred language 320 for which the website content should be customized, the domain name module(s) 325 may be configured to identify one or more TLD's associated, within TLD data records 335, with the client location 315 and/or primary/preferred language 320. As seen in the non-limiting example embodiment shown in FIG. 11, the domain name module(s) 325 may be configured to generate one or more recommended domain names including the one or more TLDs, SLDs, nth level domains and/or sub domains associated with the client location 315 and/or primary/preferred language 320. These generated domain names may then be transmitted to the client(s) 220 for display on a user interface and/or control panel.

In embodiments that determine the location 315 and/or preferred language 320 based upon an IP address of the client computer, the domain name module(s) 325 may be configured to identify the IP address of the client(s) 220 on the network. The domain name module(s) 325 may be configured to map the IP address to a real-world geographic location 315 by requesting, from a library mapping at least one IP address to at least one geo location, the location 315 of the client computer 220 based upon the IP address.

This may be accomplished using one or more available geo location databases (e.g., Ip2location, MaxMind, Tamo Soft, IPligence). Such geo location databases may get their contact, IP and/or registration information from WHOIS databases, which may be accurate down to zip code level. When an organization requires a block of IP addresses, a request may be submitted and allocated IP addresses may be assigned to a requested ISP. The server(s) 210 may then use this information to determine the location 315 and/or an associated language 320 of the IP address (i.e., the preferred language may be extrapolated from the location 315 determined by the IP address).

The domain name module(s) 325 may be configured to identify one or more TLD's associated, within TLD data records 335, with the client location 315 and/or preferred language 320. As seen in the non-limiting example embodiment shown in FIG. 13, the domain name module(s) 325 may be configured to generate one or more recommended domain names including the one or more TLDs, SLDs, nth level domains and/or sub domains associated with the location 315 and/or preferred language 320. These generated domain names may then be transmitted to the client(s) 220 for display on a user interface and/or control panel.

In some embodiments, the domain names suggested to the user may be ranked according to the location 315 and/or preferred language 320. The user interface may be configured to receive a selection from the displayed domain names and transmit the selection of the at least one domain name for registration, possibly by the domain name module(s) 325.

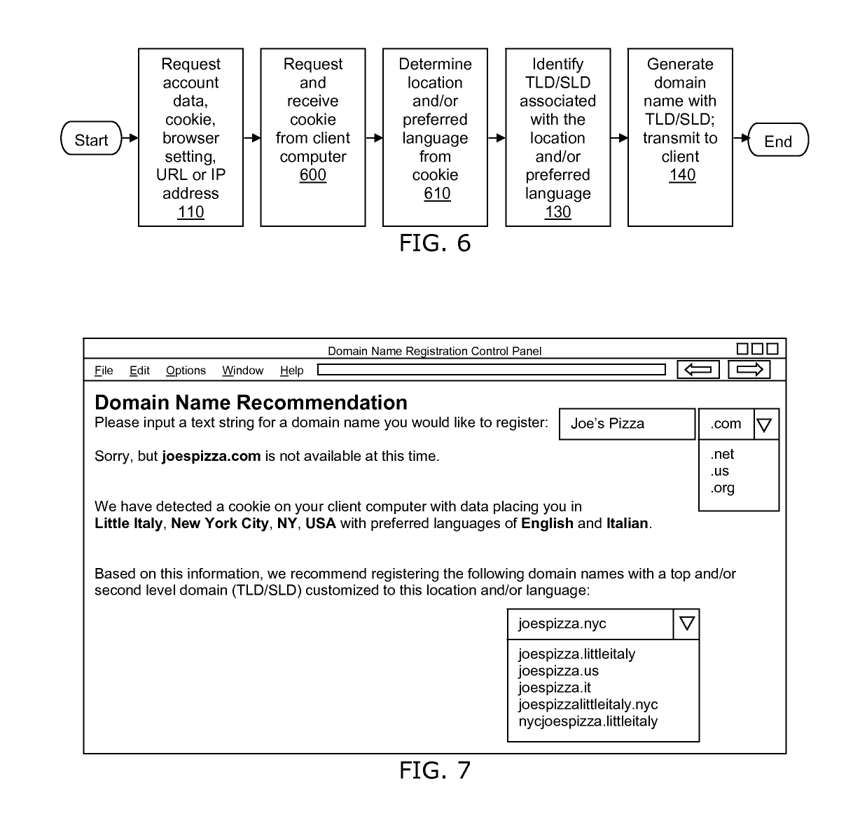

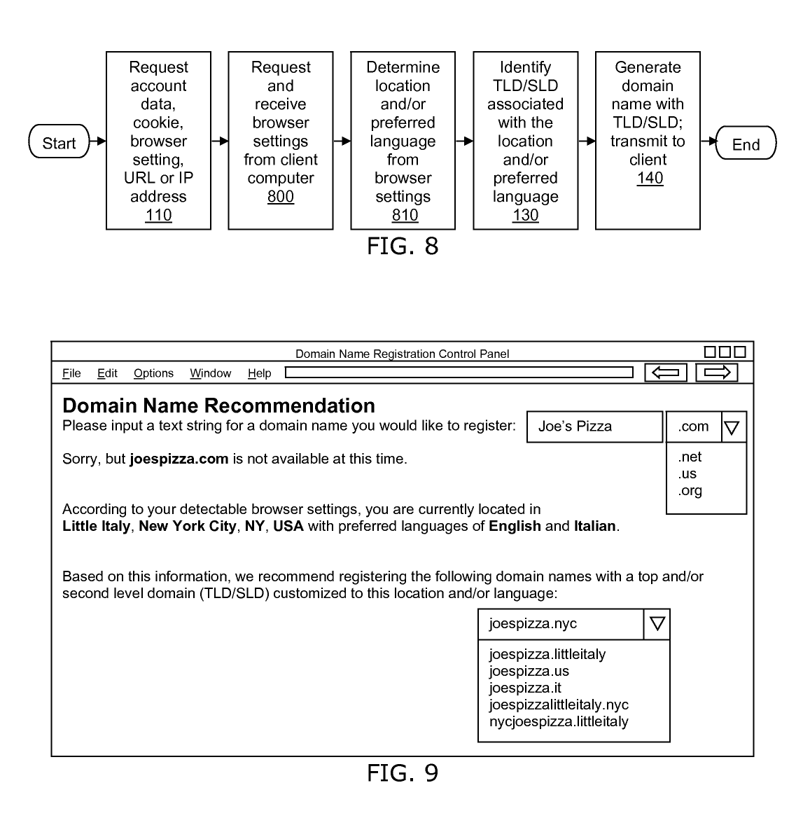

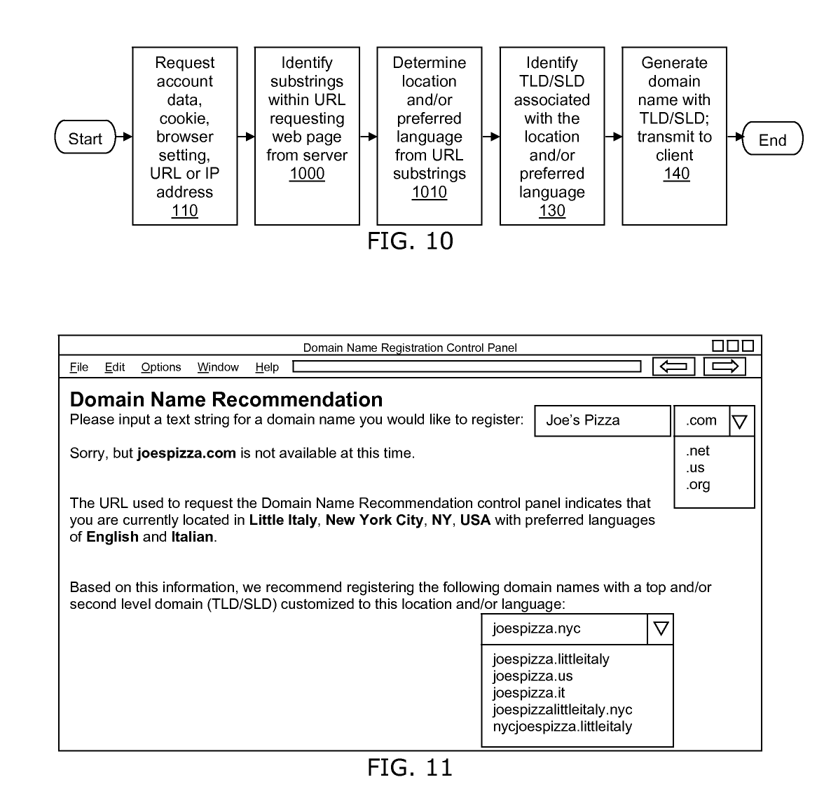

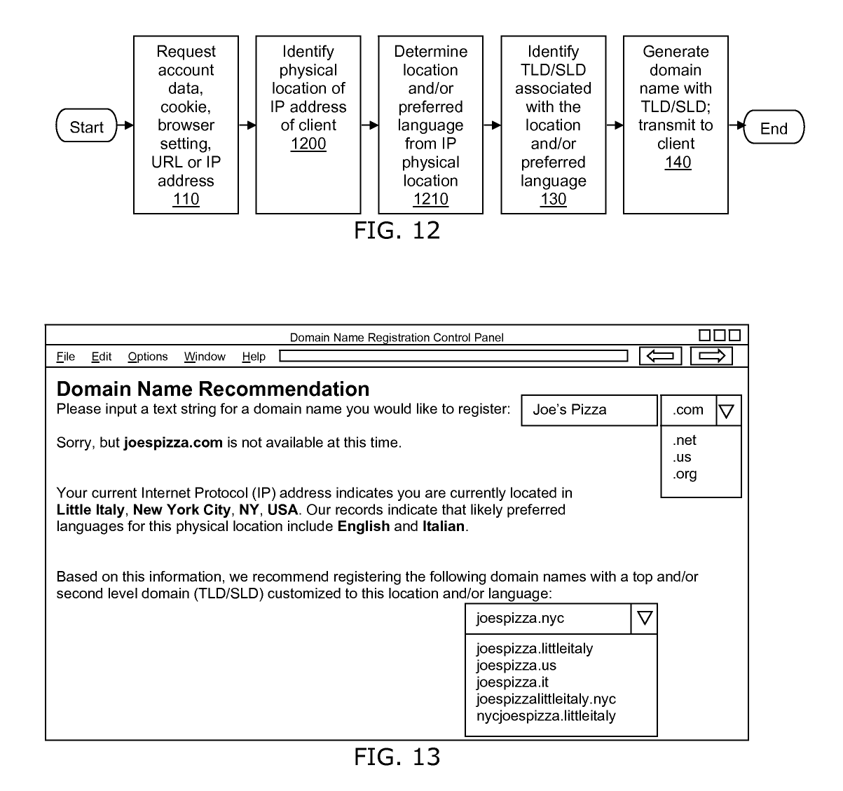

Any steps included in the embodiments illustrated in FIGS. 1-13 are not limited to their respective illustrated embodiments, and may be combined in several different orders and modified within multiple other disclosed embodiments. Likewise, the method steps disclosed herein may be accomplished by a software module executed on a server and/or client configured to accomplish that method step.

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A method, comprising the steps of:
A) determining, by a server computer communicatively coupled to a network, a location of a client computer communicatively coupled to the network, or a preferred language for a user operating the client computer, the location or the preferred language being based upon:
i) a user account for the user;
ii) a browser cookie stored on the client computer;
iii) at least one browser setting for a browser running on the client computer;
iv) a uniform resource locator resolving to a web page on the server computer; or
v) an internet protocol address of the client computer;
B) generating, by the server computer, at least one domain name comprising a second level domain concatenated to a top level domain, wherein the second level domain and the top level domain are based on the location or the preferred language; and
C) presenting for registration, by the server computer, the at least one domain name.

2. The method of claim 1, wherein the at least one top level domain is associated, in a database communicatively coupled to the network, with the location or with the preferred language.

3. The method of claim 1, wherein generating step B) further comprises the steps of:
i) receiving, by the server computer, a request for a domain name, the request comprising a text string for determining if the domain name is available for registration;
ii) identifying, by the server computer, within the text string, at least one keyword;
iii) identifying, by the server computer, within a database communicatively coupled to the network, the at least one top level domain associated, in the database, with the location or with the preferred language;
iv) generating, by the server computer, the at least one domain name, wherein the at least one domain name:
a) comprises the at least one keyword within a second-level domain of the domain name;
b) comprises the at least one top level domain; and
c) is available for registration.

4. The method of claim 1, wherein the top level domain comprises:
i) a country code top level domain; or
ii) a customized generic top level domain.

5. The method of claim 2, wherein generating step B) further comprises the steps of:
i) receiving, by the server computer, a request for a domain name, the request comprising a text string for determining if the domain name is available for registration;
ii) identifying, by the server computer, within the text string, at least one keyword;
iii) generating, by the server computer, the at least one domain name, wherein the at least one domain name:
a) comprises the at least one keyword within the second level domain;
b) comprises the location or the preferred language within the second level domain; and
c) is available for registration.

6. The method of claim 5, wherein the second level domain comprises the location or the preferred language appended as a prefix or a suffix to the at least one keyword.

7. The method of claim 1, wherein determining step A) further comprises the steps of:
i) determining, by the server computer, whether a database communicatively coupled to the network comprises a user account data record for the user; and
ii) responsive to a determination that the database comprises the user account data record for the user, identifying, by the server computer, within the user account data record, the location or the preferred language.

8. The method of claim 1, wherein determining step A) further comprises the steps of:
i) receiving, by the server computer, from the client computer, the browser cookie; and
ii) identifying, by the server computer, within the browser cookie, the location or the preferred language.

9. The method of claim 1, wherein determining step A) further comprises the steps of:
i) receiving, by the server computer, the at least one browser setting comprising:
a) a geo location of the client computer; or
b) a language preference setting; and
ii) identifying, by the server computer:
a) the location as the geo location; or
b) the preferred language as the language preference setting.

10. The method of claim 1, wherein determining step A) further comprises the steps of:
i) identifying, by the server computer, a sub string within the uniform resource locator representing:
a) a client location for which a website content should be customized; or
b) a primary language for which the website content should be customized; and
ii) identifying, by the server computer:
a) the location as the client location; or
b) the preferred language as the primary language.

11. The method of claim 1, wherein determining step A) further comprises the steps of:
i) identifying, by the server computer, the internet protocol address on the network for the client computer;
ii) requesting, by the server computer, from a library mapping at least one internet protocol addresses to at least one geo location, the location of the client computer based on the internet protocol address; and
iii) receiving, by the server computer, the location of the client computer.

12. A system, comprising a server communicatively coupled to a network and running a domain name module configured to:
A) determine a location of a client computer communicatively coupled to the network, or a preferred language for a user operating the client computer, the location or the preferred language being based upon:
i) a user account for the user;
ii) a browser cookie stored on the client computer;
iii) at least one browser setting for a browser running on the client computer;
iv) a uniform resource locator resolving to a web page on the server computer; or
v) an internet protocol address of the client computer;
B) generate at least one domain name based on the location or the preferred language; and
C) present, for registration, the at least one domain name.

13. The system of claim 12, wherein the at least one top level domain is associated, in a database communicatively coupled to the network, with the location or with the preferred language.

14. The system of claim 12, wherein the domain name module is further configured to:
i) receive a request for a domain name, the request comprising a text string for determining if the domain name is available for registration;
ii) identify, within the text string, at least one keyword;
iii) identify, within a database communicatively coupled to the network, the at least one top level domain associated, in the database, with the location or with the preferred language;
iv) generate the at least one domain name, wherein the at least one domain name:
a) comprises the at least one keyword within a second-level domain of the domain name;
b) comprises the at least one top level domain; and
c) is available for registration.

15. The system of claim 12, wherein the top level domain comprises:
i) a country code top level domain; or
ii) a customized generic top level domain.

16. The system of claim 12, wherein the domain name module is further configured to:
i) receive a request for a domain name, the request comprising a text string for determining if the domain name is available for registration;
ii) identify, within the text string, at least one keyword;
iii) generate the at least one domain name, wherein the at least one domain name:
a) comprises the at least one keyword within the second level domain;
b) comprises the location or the preferred language within the second level domain; and
c) is available for registration.

17. The system of claim 16, wherein the second level domain comprises the location or the preferred language appended as a prefix or a suffix to the at least one keyword.
